(19) United States
(12) Patent Application Publication
(10) Pub. No.: US 2010/0030808 A1
(43) Pub. Date: Feb. 4, 2010

(54) MULTIMEDIA ARCHITECTURE FOR AUDIO AND VISUAL CONTENT

(75) Inventors: David P. Ress, Cary, NC (US); Dominic Goodwill, Kanata (CA); Kenneth Feldmann, Efland, NC (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 12/183,616

(22) Filed: Jul. 31, 2008

(51) Int. Cl. G06F 17/30

(52) U.S. Cl. 707/104.1; 707/E17.009

(57) ABSTRACT

A multimedia architecture for audio and video content. The architecture includes virtual assets that model, or are associated with, a media presentation and one or more real assets that model, or are associated with, digitally encoded embodiments of the media presentation. The architecture enables automatic selection of content in a format that is optimal for a particular device, shielding a user from the complexities of multiple digital formats.

### FIELD OF THE INVENTION

The present invention relates generally to a multimedia architecture, and in particular to a multimedia architecture for audio and visual content which enables automatic format selection of a requested multimedia presentation.

### BACKGROUND OF THE INVENTION

Playing audio and visual content on digital devices is increasingly popular today. Because content can be formatted into many different digital formats, consumers must typically have some knowledge of what digital formats are suitable for the particular device on which the consumer intends to play the content. Absent such knowledge, a consumer may purchase digital content that is incompatible with or not optimal for the digital device on which the consumer would like to play the content. Services that offer digital content in different digital formats and require a customer to select the optimal format for their device can cause customer confusion and may result in customer dissatisfaction and increased support costs. Cable operators and telephone service providers are increasingly offering digital content to their customers and must support a wide range of devices. It is apparent that as service offerings of digital content increases, it will become increasingly important to shield the consumer from the complexities related to ensuring the digital content the consumer purchases is compatible with or otherwise best suited for a particular digital device.

### SUMMARY OF THE INVENTION

The present invention relates to a multimedia architecture for audio and visual content that enables a multimedia system to determine and automatically select the optimal digital content for a particular user device based on one or more factors without direction from a user. The present invention can shield the end user from the complexity associated with the multiple and often competing digital formats in which a media presentation may be encoded.

As used herein, the phrase ‘media presentation’ refers generically to a consumable item such as a movie, or a song. For example, a Batman movie, a Batman trailer and a Batman poster are all consumable items, and each may be referred to generically herein as a media presentation. Media presentations can be embodied in a digital encoding in a particular digital format, and may be embodied in several digital encodings, each of which is in a different digital format. According to one embodiment of the present invention, a media presentation is modeled as a virtual asset, and digital encodings are modeled as real assets. There may be multiple categories of virtual assets, such as commercial virtual assets and promotional virtual assets. A commercial virtual asset is associated with a media presentation that a consumer may desire to purchase. A promotional virtual asset is associated with a media presentation that might be used to entice or otherwise encourage the purchase of the media presentation associated with the commercial virtual asset. For example, the Batman movie may be associated with a commercial virtual asset, and the Batman poster may be associated with a promotional virtual asset.

Each virtual asset is associated with one or more real assets. Each real asset is associated with a rendering of the media presentation in a specific digital format. The actual digitally encoded file, or stream, can be referred to as a content item, but preferably it is the real asset associated with the content item that contains metadata describing encoding characteristics of the content item and that is used to make determinations about compatibility with a user device. The virtual asset can include metadata items describing the virtual asset, and can include, for example, a title of the media presentation, a genre of the media presentation, and a performance length of the media presentation. A real asset can also include metadata items describing the real asset and the content item with which it is associated, and can include, for example, a location of, or link to, the content item and a format type identifying the specific digital format of the content item. The virtual asset and its associated real assets together form an asset structure.

A user device can register with a multimedia system employing the multimedia architecture of the present invention and can communicate information including a device type, types of digital formats playable by the user device, and capabilities of the network to which the user device is connected to the multimedia system. The multimedia system can generate a guide identifying media presentations for which real assets exist that are suitable for playing on the user device given the device type, types of digital formats playable by the user device, or network capabilities. The multimedia system can prevent presenting media presentations to the user for which there are no real assets suitable for playing on the user device. A user can select one of the media presentations identified in the guide, and the multimedia system can automatically select the real asset associated with a content item that is optimally formatted in a digital format best suited for the user device, eliminating the need for the user to have knowledge regarding what digital format is optimal for the specific user device. The content item can be streamed to the user device by a streaming server, or otherwise downloaded to the user device.

According to another embodiment of the present invention, media productions are used to group one or more commercial virtual assets with one or more promotional virtual assets into a single consumable package. The media production can include metadata describing the cost of the particular consumable package and an availability date, for example. A user may be able to request that media presentations associated with the one or more promotional virtual assets be played, or otherwise consumed, prior to purchasing the commercial virtual asset associated with the media production.

According to another embodiment of the present invention, the multimedia system does not have a real asset in an optimal digital format for the user device, and the multimedia system generates and communicates a transcoding message to the streaming server to generate a rendered media presentation in an optimal digital format for the user device from a real asset that is in a non-optimal digital format. The real asset associated with the content item from which the media presentation will be rendered can have a policy metadata item that indicates whether such transcoding is permissible, in accordance with respective licensing rights.

According to another embodiment of the present invention, a first user device can notify the multimedia system to halt streaming of a media presentation on the first user device and begin streaming the media presentation to a second user device, even though a different digital encoding is best suited for the second user device than the digital encoding best suited for the first user device. The multimedia system can determine the current position of the content item being streamed to the first user device, halt streaming of the content item to the first user device, determine the device type, types of digital formats playable, or network capabilities associated with the second user device, select a real asset associated with the media presentation and with a content item in an optimal digital format for the second user device, and initiate streaming of the content item to the second user device at substantially the same position in the media presentation where the streaming was halted on the first user device. Alternately, device information, such as types of digital formats playable for various device types, can be stored in the multimedia system and can be obtained by the multimedia system from such storage rather than directly from the user device.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a Unified Modeling Language (UML) model of a class diagram suitable for implementing aspects of a multimedia architecture according to one embodiment of the present invention.

FIGS. 2A and 2B are a UML model of an object domain instance diagram illustrating exemplary virtual assets and real assets according to one embodiment of the present invention.

FIG. 3 is a multimedia system environment illustrating modules suitable for use with the multimedia architecture according to one embodiment of the present invention.

FIG. 4 is a flow diagram illustrating a process for asset and content ingest according to one embodiment of the present invention.

FIG. 5 is a flow diagram illustrating a process for a multimedia session request and automatic selection of an optimal real asset for a user device according to one embodiment of the present invention.

FIGS. 6A and 6B are a flow diagram illustrating a process for fulfilling a request for a media presentation, wherein a content item is used in a transcoding process to generate a media presentation in an optimal format for the user device according to one embodiment of the present invention.

FIG. 7 is a flow diagram illustrating a process utilizing a service data request to provide a customized catalog according to one embodiment of the present invention.

FIGS. 8A and 8B are a flow diagram illustrating a process for transferring a media presentation from a first user device to a second user device according to one embodiment of the present invention.

FIG. 9 is a block representation of a session manager according to one embodiment of the present invention.

FIG. 10 is a block representation of a catalog service according to one embodiment of the present invention.

FIG. 11 is a block representation of an application server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to a multimedia architecture for audio and visual content that, among other advantages, enables a multimedia system to determine and automatically select a media presentation in an optimal digital format for a particular user device based on device capabilities and, where appropriate, network constraints. The present invention can shield a consumer from the complexity associated with multiple and often competing digital formats in which a multimedia presentation may be encoded. The present invention also enables a provider to create a single commercial media presentation offer to subscribers regardless of device or access type.

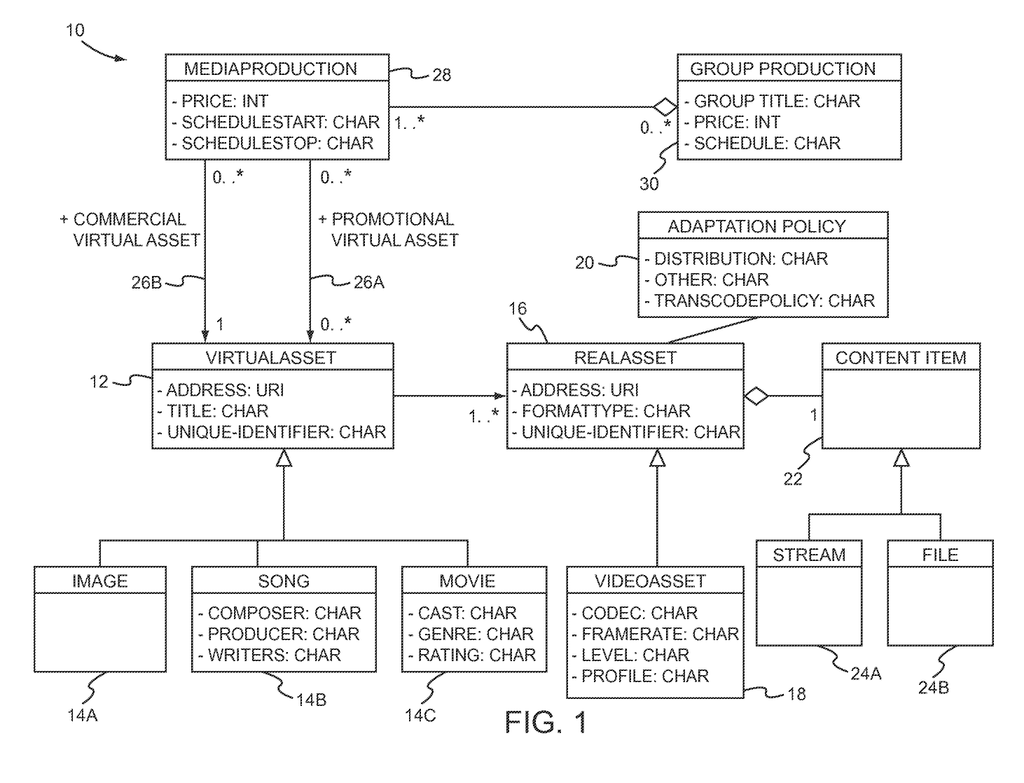

Referring now to FIG. 1, a Unified Modeling Language (UML) model of a class diagram 10 suitable for implementing aspects of a multimedia architecture is shown according to one embodiment of the present invention. As will be appreciated by those skilled in the art, notations on the class diagram 10 next to the classes denote multiplicity of instances of the respective class, where “1” denotes one instance, “1 . . . *” denotes one or more instances, and “0 . . . *” or “*” denotes zero or more instances. An aggregation relationship between instances of classes is denoted by a hollow diamond, and a generalization relationship between two classes is denoted by a hollow triangle. A virtual asset 12 is associated with a particular media presentation. The phrase ‘media presentation’ as used herein is a generic reference to an item that may be played, listened to, or otherwise consumed by a consumer. By generic, it is meant that the media presentation is an identifier of the consumable item. For example, references to the movie Batman, the song “Who's Next,” and a Batman poster are all media presentations. Examples of media presentation types that can be associated with the virtual asset 12 include, but are not limited to, an image media presentation type 14A, a song media presentation type 14B and a movie media presentation type 14C. The virtual asset 12 can include metadata describing the media presentation with which it is associated. For example, if the media presentation is a movie, the metadata can include a title of the media presentation, a cast of the media presentation, a genre of the media presentation, and a rating of the media presentation. The virtual asset 12 also has a particular address or identifier by which it can be accessed and identified by a multimedia system. According to one embodiment of the present invention, the address is a uniform resource identifier (URI); however, it will be apparent that the address can be any mechanism for identifying and obtaining the virtual asset 12 as appropriate for the particular system in which it is being utilized.

The media presentation will be embodied in one or more tangible embodiments, such as a digital encoding of the media presentation. Each such tangible embodiment of the media presentation associated with the virtual asset 12, for example digital encodings of the movie Batman, are associated with a real asset 16. While the real asset 16 will be frequently described herein as being a video type real asset 18, it will be apparent that the real asset 16 can be any suitable type as is appropriate for the respective media presentation, including a song, a poster, and the like. The real asset 16 includes metadata describing characteristics of the specific tangible embodiment of the media presentation. Assuming that the real asset 18 is a video type real asset 18, the metadata can include a format type, such as high definition (HD) or standard definition (SD), a codec type, a frame rate, a level, and a profile, but it should be apparent that the particular metadata may differ depending on the type of media presentation embodiment that is associated with the real asset 16. The real asset 16 also has an address by which the real asset 16 can be accessed, such as a URI. The type of link used to access the real asset 16 can be the same type of link used to access the virtual asset 12, or can be a different type of link. For example, virtual assets 12 may be accessed via Session Initiation Protocol (SIP) or Hypertext Transfer Protocol (HTTP) URIs, while real assets 16 may be accessed via Real Time Streaming Protocol (RTSP) or HTTP URIs. The real asset 16 can also have an associated policy 20. The policy 20 can contain rules that govern the use of the digital encoding associated with the real asset 16. For example, the policy 20 might indicate that appropriate license rights exist such that the digital encoding can be used in a transcoding process to reformat the digital encoding into a different format. The policy 20 might also indicate a limited number of types of digital encodings that can be generated, such as Moving Picture Experts Group (MPEG) 4, but not MPEG2.

The real asset 16 has a link, address, or other pointer to the actual digital encoding with which the real asset 16 is associated. The actual digital encoding is modeled as a content item 22. The content item 22 can be any of various types of digital encodings, depending on the type of media presentation, and could be, for example, a stream type 24A or a file type 24B.

If suitable for the particular application in which the virtual asset 12 is being utilized, and as will be described in an embodiment discussed herein, the virtual asset 12 can be further categorized as having a particular role, such as a commercial role or a promotional role. Roles are expressed in the UML model illustrated in FIG. 1 as a promotional virtual asset role 26A and a commercial virtual asset role 26B. By role, it is meant that an implementer of the multimedia architecture may find it useful to categorize virtual assets 12 as having different roles or functions, but such categorization is optional. As used herein, a virtual asset 12 may be described as a commercial virtual asset or a promotional virtual asset, and it will be understood this means that the particular virtual asset 12 being discussed is being categorized into that particular role. For example, a virtual asset 12 associated with a media presentation that a consumer may desire to purchase may be referred to as having a commercial role, and therefore be described as a commercial virtual asset, and a media presentation that might be used to entice or otherwise encourage the purchase of the media presentation associated with the commercial virtual asset may be described as having a promotional role, and therefore be described as a promotional virtual asset. However, whether the virtual asset 12 has a promotional or commercial role, the underlying structure of the virtual asset 12 preferably remains the same as does the relationship between the virtual assets 12 and the real assets 16, as described herein.

As a specific example, the Batman movie may be associated with a commercial virtual asset, and the Batman poster may be associated with a promotional virtual asset. However, the virtual asset role used to represent a media presentation may differ depending on the particular nature of the business. For example, a poster store may associate a Batman poster with a commercial virtual asset and a Batman Joint Photographic Experts Group (JPEG or JPG) file with a promotional virtual asset. While the categorization of virtual assets 12 into different roles may be useful for constructing a media presentation, it is not necessary for practicing the broader aspects of the present invention. The virtual asset 12 is the asset that is selected by a consumer or other user of the multimedia system. Because the virtual asset 12 represents a media presentation identifier rather than a specific digital encoding of the media presentation, the user need not be concerned with the underlying details of digital formats and device types. The multimedia system, as described in greater detail herein, utilizes the virtual asset 12 to select a particular real asset 16 based on the device information of the device associated with the user. The multimedia system thus improves the overall experience of the user by eliminating the complexities of different digital formats with different types of digital devices.

If desired, a media production 28 can be used to group, or package, one or more virtual assets 12 into a product offering for a consumer. For purposes of convenience, assume roles, as described previously, are being used to categorize virtual assets 12. The media production 28 can contain one or more commercial virtual assets and one or more promotional virtual assets. The consumer may be able to select the promotional virtual assets prior to purchasing the commercial virtual assets. The media production 28 enables different product offerings for the same virtual asset 12.

A group production 30 can be used to group one or more media productions 28. The group production 30 enables packaging of multiple media productions 28 together such that each individual media production 28 is available to the consumer if the group production 30 is selected or purchased. Examples of a group production 30 may include the Lord of the Rings trilogy, a Led Zeppelin box set, Season Two of Battlestar Galactica, or a Julia Roberts marathon.

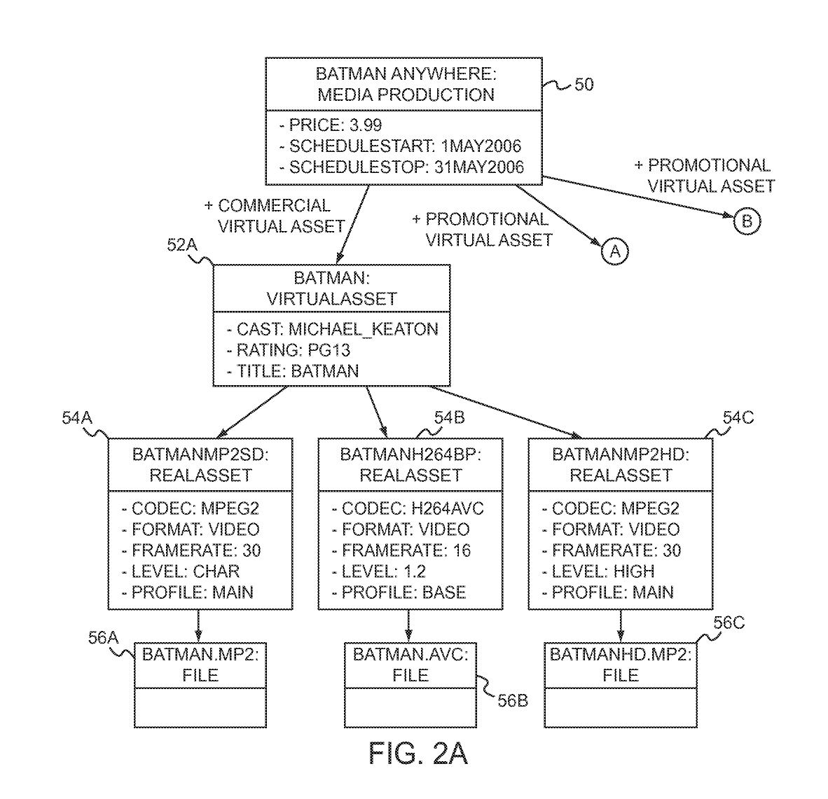

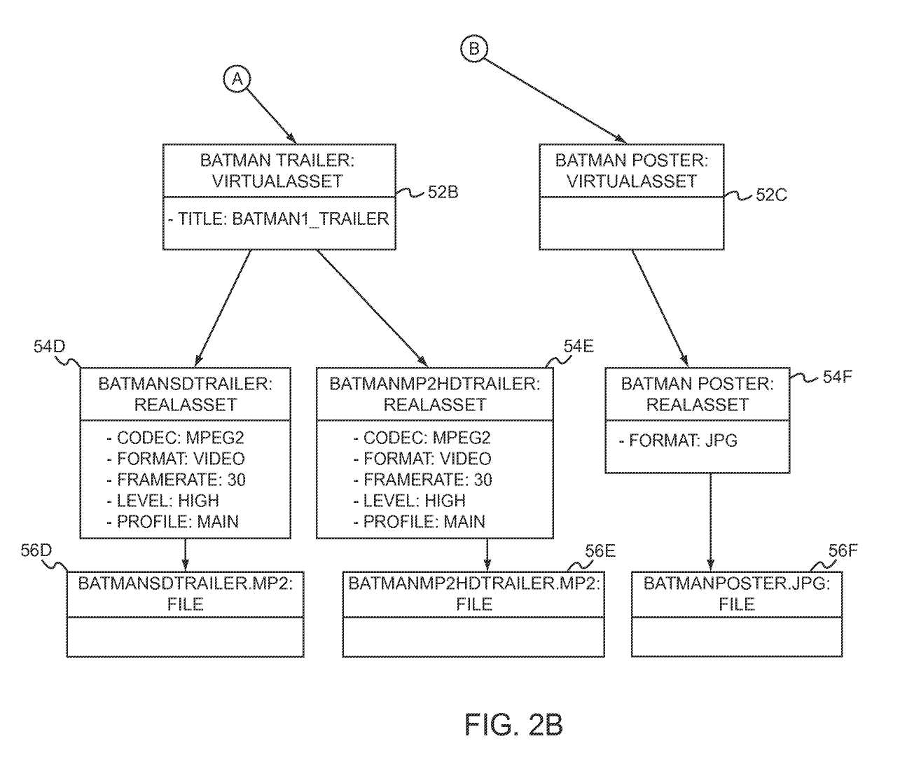

FIGS. 2A and 2B are a UML model of an object domain instance diagram illustrating exemplary virtual assets and real assets according to one embodiment of the present invention. It will be assumed the example illustrates the use of aspects of the present invention by a provider of movies, and further that the provider uses roles to further categorize virtual assets as commercial virtual assets and promotional virtual assets, as described above with reference to FIG. 1. A media production 50 can be presented to a user and have a title “Batman Anywhere,” a price of $3.99, and be available for purchase from May 1, 2006-May 3, 2006. The media production 50 is associated with a commercial virtual asset 52A, which is associated with the media presentation Batman, and further contains cast metadata including a title of the movie Batman, a cast “Michael Keaton,” and a rating “PG-13.” The metadata discussed herein is merely representative and can comprise any information relating to the media presentation that the respective provider may wish to present to a user. The media production 50 is also associated with a promotional virtual asset 52B, which is associated with a Batman trailer media presentation, and a promotional virtual asset 52C, which is associated with a Batman poster media presentation. Although implementation dependent, a user may be able to select and consume the content associated with the promotional virtual assets 52B and 52C prior to purchasing the media production 50.

The commercial virtual asset 52A is associated with real assets 54A, 54B, and 54C. Because each of the real assets 54A, 54B, and 54C are associated with a digital encoding of the movie Batman, each has metadata describing the actual digital encoding with which they are associated, such as the codec used to encode the movie, the frame rate at which it was encoded, and the profile used to encode the movie. The multimedia system, as described herein, can use this metadata to select one of the real assets 54A, 54B, and 54C for a particular user device depending on the capabilities of the user device. Each of the real assets 54A, 54B, and 54C is associated with and has a link, address, or other pointer to a respective content item 56A, 56B, and 56C, which is the actual digital encoding, such as a file or stream, of the respective media presentation. Because there is a one-to-one relationship between a real asset and a content item, the present invention may be described herein as selecting and streaming real assets to users, and it will be understood that while the real assets 54A, 54B, and 54C are used to determine which content is optimal for a user device, ultimately the multimedia system obtains the link or address to the respective content item 56A, 56B, and 56C and streams the content item 56A, 56B, and 56C associated with the selected real asset 54A, 54B, and 54C to the user device.

The promotional virtual asset 52B is associated with real assets 54D and 54E. Since the real assets 54D and 54E are associated with video media presentations, they can contain the same metadata as described with respect to the real assets 54A, 54B, and 54C. Each of the real assets 54D and 54E contain a link or address to the respective digital encoding illustrated by content items 56D and 56E, respectively. The promotional virtual asset 52C is associated with a real asset 54F. The real asset 54F is associated with a poster media presentation, and has a metadata item indicating that the digital encoding of the Batman poster with which it is associated is a JPG file. The real asset 54F has a link or address to the actual Batman poster, as illustrated by content item 56F.

According to one embodiment of the present invention, the structures described herein, including media productions, virtual assets, and real assets, can be implemented in a data processing environment as an object, a record, or other type of data structure. Moreover, it should be apparent that the underlying structure of the virtual assets and real assets could be implemented through any conventional techniques known to those skilled in the art suitable for establishing the relationships described herein and capable of storing the information described herein.

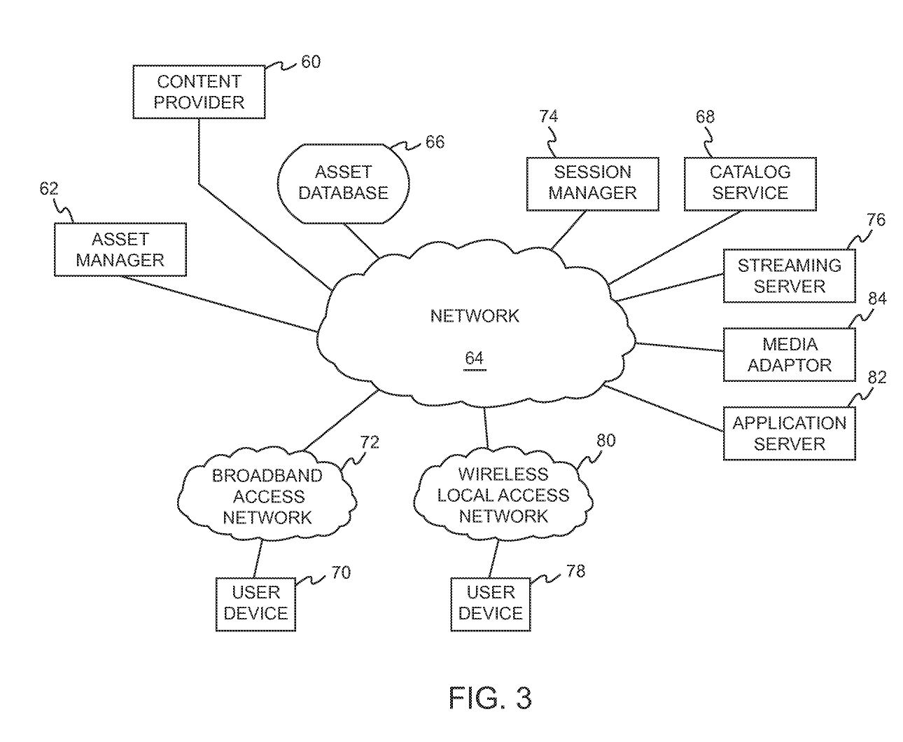

Referring now to FIG. 3, modules of a multimedia system suitable for carrying out aspects of the present invention are illustrated. As will be appreciated by those skilled in the art, message and data flow with and between the modules of the multimedia system can be implemented through the use of various conventional communications protocols, including HTTP, SOAP/HTTP, SIP, and RTSP, or can be implemented using proprietary communications protocols; however, the present invention is not limited to any particular messaging protocol. One embodiment of the present invention can be implemented in an internet protocol Multimedia Subsystem (IMS) environment, as described in U.S. patent application Ser. No. 11/563,306, filed Nov. 27, 2006, entitled MULTIMEDIA SUBSYSTEM CONTROL FOR INTERNET PROTOCOL BASED TELEVISION SERVICES, the disclosure of which is hereby incorporated herein by reference in its entirety.

A content provider 60 provides one or more digital encodings of a media presentation, or content items, to an asset manager 62. A network 64 facilitates communications between the asset manager 62 and the content provider 60, as well as between other elements and modules as discussed herein. The network 64 can comprise any suitable communications medium or mediums. The asset manager 62 stores a copy of each content item in an asset database 66. For purposes of illustration, the content items, real assets, and virtual assets will be described herein as being stored in the asset database 66, but it will be apparent to those skilled in the art that the various structures and digital content could be stored in separate storage locations apart from one another and, if appropriate, separated geographically, so long as the relationship between the various elements is maintained. Techniques for loading, storing, and/or otherwise creating digital encodings on a storage medium are known to those skilled in the art and will not be described in detail herein.

Along with the content item, the content provider 60 can provide a real asset associated with the content item to the asset manager 62. The associated real asset is also stored in the asset database 66. As discussed previously, each real asset is associated with a specific digital encoding, or content item, of a media presentation and has a URI or other link, address, or pointer to the respective content item, and can include information, such as metadata, relating to the content item with which it is associated. The creation and storage of content items and real assets may be manual or may be automated.

The content provider 60 can also provide a virtual asset associated with the real asset to the asset manager 62, or alternatively, the asset manager 62 can generate a virtual asset and store the virtual asset in the asset database 66. As discussed with regard to FIG. 1, a virtual asset represents a media presentation for which there are one or more real assets associated with content items encoded in a specific digital format. According to one embodiment of the present invention, a virtual asset and its associated real assets can collectively comprise an asset structure.

A user device 70 can initialize and register with the multimedia system over a broadband access network 72, which can comprise, for example, a Digital Subscriber Line (DSL) or high-speed cable network. After such registration, a catalog service 68 can provide the user device 70 with a guide or catalog identifying names of media presentations associated with the virtual assets contained in the asset database 66. The user device 70 can present the guide to a user, who can select a particular media presentation from the guide. The user device 70 obtains a URI from the guide to the virtual asset associated with the media presentation selected by the user and requests a session manager 74 to initiate a media session. The user device 70 then passes device information describing characteristics of the user device 70, such as a device type, types of digital formats playable by the user device 70, or network capabilities associated with the user device 70, to the session manager 74. Alternately, the multimedia system can have a repository (not shown) that contains information identifying device capabilities of various devices that are permitted to connect to the multimedia system, wherein the device merely needs to communicate a respective device type to the session manager 74, and the multimedia system obtains the device capabilities for that device type from the repository.

The session manager 74 obtains the asset structure associated with the selected virtual asset from the asset database 66, and determines which real asset in the asset structure is the optimally formatted real asset for the user device 70 given the device type, types of digital formats playable by the user device 70, or network capabilities associated with the user device 70. Network capabilities that may be used by the session manager 74 to select an optimally formatted real asset may include bandwidth availability or stability, support of various transport mechanisms such as internet protocol (IP) multicast, over the air broadcast, and the like, reliability, grade of service, quality of service, or class of service. The user device 70 can then request that a streaming server 76 begin streaming the content item associated with the selected real asset to the user device 70.

While the content item is being streamed to the user device 70, the user may indicate to the user device 70 a desire to transfer the playing of the media presentation to another user device 78. The user device 78 may, for example, be a mobile device connected to the network 64 via a wireless local access network 80. Upon such a request by the user device 70, the multimedia system can stop streaming the content item to the user device 70, determine which real asset in the asset structure has an associated content item that is optimally formatted for the user device 78, and begin streaming the content item to the user device 78 at the location in the presentation where it was halted on the user device 70.

According to another embodiment of the present invention, the user device 70 can initiate a service data request requesting a customized guide, or catalog, identifying only those virtual assets for which a real asset suitable for playing on the user device 70 exists and, optionally, limited to virtual assets to which a particular subscriber is subscribed. Such a customized guide of virtual assets can eliminate presenting media presentations to a user for which there is no corresponding real asset suitable for the user device 70. In an embodiment in which SIP is utilized, such a service data request can be sent to a SIP application server, such as an application server 82, which might be designated as the application server that receives all SIP messages. In a non-SIP environment, such a service data request might be sent directly to the catalog service 68.

According to another embodiment of the present invention, the user device 70 requests a virtual asset for which no real asset having a content item suitable for the user device 70 exists, but the session manager 74 determines that a real asset exists that has an associated content item from which a suitable rendering could be generated. The session manager 74 initiates a session with a transcoder, such as a media adaptor 84, which receives the content item from which a suitable rendering can be generated from the streaming server 76, transcodes the content item into a format suitable for the user device 70, and streams the transcoded content item to the user device 70. The selection of the real asset best suited for the transcoding process, and the transcoding process itself, is transparent to the user.

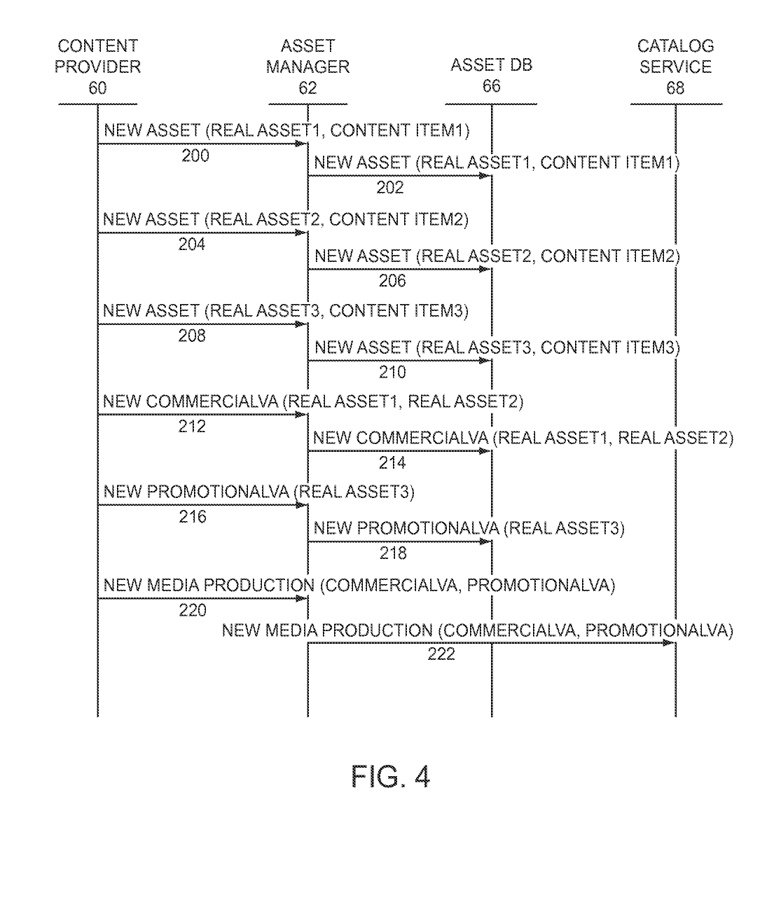

Exemplary embodiments of the present invention are provided in the following communication flows illustrated in FIGS. 4-8. As presented, the present invention includes multiple features that are optional and need not be employed to carry out the concepts of the overall invention. Referring now to FIG. 4, a communication flow is provided to illustrate asset and content ingest in a multimedia architecture according to one embodiment of the present invention. The content provider 60 can provide a new real asset 1 and an associated content item 1 of a media presentation to the asset manager 62 (step 200). The asset manager 62 can be an automated process or a manual process. The asset database 66 can comprise any suitable database or other means for organizing data on a storage medium and, as mentioned previously, the content items could be stored on a medium that is separate from that used to store the virtual and real assets. The asset manager 62 sends the real asset 1 and the content item 1 to the asset database 66 for storage (step 202). Additional real assets 2 and 3 and associated respective content items 2 and 3 are then provided by the content provider 60 to the asset manager 62 and stored in the asset database 66 (steps 204-210).

It will be assumed for purposes of illustration that the content provider 60 categorizes virtual assets into various roles, such as the commercial and promotional roles discussed herein. The content provider 60 provides a commercial virtual asset that is associated with the real assets 1 and the real asset 2 to the asset manager 62, which stores the commercial virtual asset in the asset database 66 (steps 212 and 214). The content provider 60 then provides a promotional virtual asset that is associated with the real asset 3 to the asset manager 62, which in turn stores the promotional virtual asset in the asset database 66 (steps 216 and 218). The content provider 60 then provides a media production that is associated with the commercial virtual asset and the promotional virtual asset to the asset manager 62 (step 220). Because media productions are purchasable groupings of commercial and virtual assets, the asset manager 62 provides the media production to the catalog service 68 for later presentation to a user device upon request (step 222).

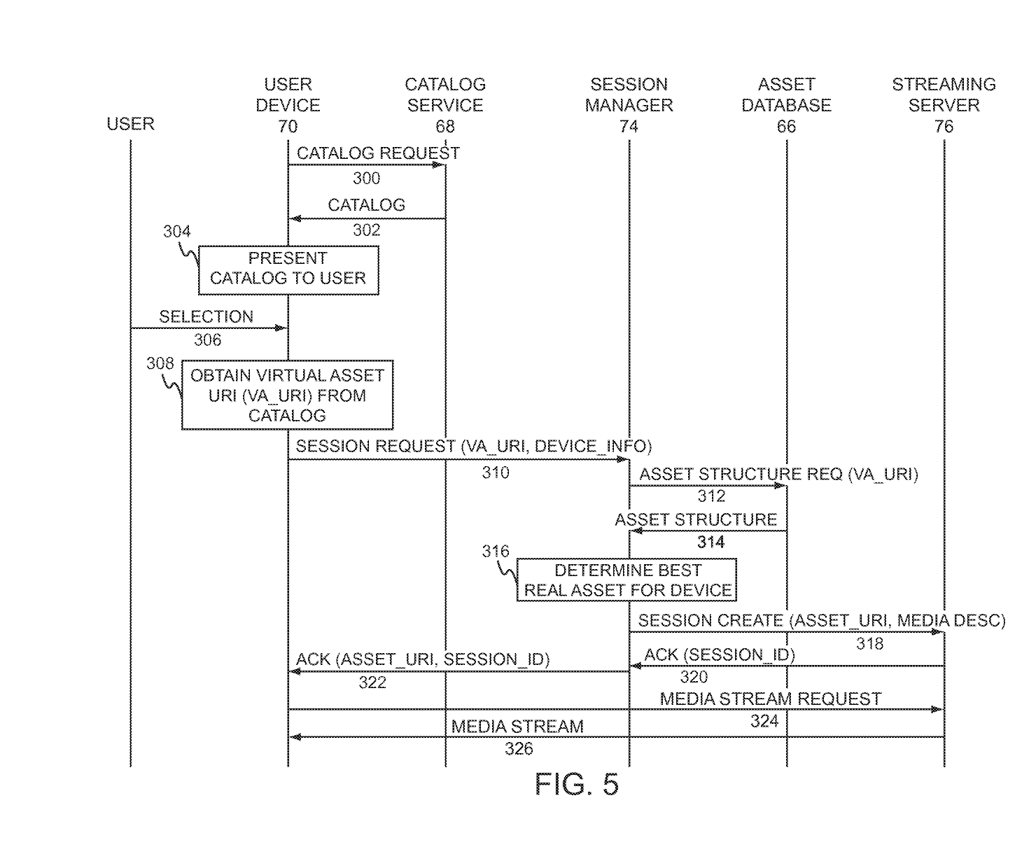

Referring now to FIG. 5, a communication flow is provided to illustrate a process for automatic selection of an optimal real asset for a user device according to one embodiment of the present invention. It is assumed that the user device 70 has already initialized and registered with the multimedia system. Mechanisms for device registration in multimedia systems are known to those skilled in the art and will not be described herein. The user device 70 requests a catalog of available virtual assets from the catalog service 68 (step 300). In response, the catalog service 68 returns a catalog of the virtual assets available in the multimedia system and any associated metadata to the user device 70 (step 302). The catalog can be in any suitable format understandable by the user device 70, including an Extensible Markup Language (XML) format. The catalog may be downloaded in part or in its entirety onto the user device 70, or the user device 70 may browse the catalog on the catalog service 68 in response to user commands. The catalog preferably includes URIs to the virtual assets. If the system provider uses media productions, the catalog can comprise any suitable information generated from media productions, such as URIs to the commercial virtual assets and promotional virtual assets and any metadata associated with the media production, such as price and availability, or with the virtual assets, such as genre, rating, and the like. According to another embodiment of the present invention, the catalog service 68 may substitute URIs of real assets for URIs of virtual assets if the device capabilities of the user device 70 are known, or if the real asset format is known to be supported by all user devices supported by the system, such as, for example, a JPG image file.

The user device 70 can format this information in any desired manner and can present the information to a user (step 304). The user device 70 can comprise any suitable device or functional module capable of communicating with a network and capable of processing data, including an application program running on a conventional computer, a Blu-Ray player, a television, a handheld apparatus such as a mobile phone or a personal digital assistant (PDA), a television set top box, or the like, and the display can comprise any conventional mechanism for communicating with a user given that respective type of device. The user device 70 receives a selection from the user (step 306) and can obtain the URI of the virtual asset (VA_URI) from the catalog (step 308). The user device 70 can then initiate a session request message to the session manager 74, including in the request the VA_URI and information relating to the capabilities of the user device 70, such as a device type, the digital formats playable by the user device 70, and the network capabilities associated with the user device 70 (step 310).

While the messaging between the user device 70 and the session manager 74 can comprise any suitable standards-based or proprietary messaging format, SIP can be used according to one embodiment of the present invention. According to one embodiment of the present invention, the virtual asset URI is a SIP URI and the SIP request is addressed to the virtual asset using the address-of-record field in the To header using the following format:
vassetid@videoappserver.serviceprovider.com,
   where vassetid is the unique identifier of the virtual asset and videoappserver is the name of the session manager 74 in the domain of serviceprovider.com. In another embodiment of the present invention, an IMS wildcarded public service identifier can be used to route all requests to virtual assets to the videoappserver. In this embodiment of the present invention, the wildcarded public service identifier is of the format *.videoappserver.serviceprovider.com. In conjunction with SIP, Session Description Protocol (SDP) can be used to provide all or a portion of the device information.

Upon receipt of the session request message, the session manager 74 initiates an asset structure request to the asset database 66 (step 312). The asset database 66 returns to the session manager 74 a copy of the asset structure associated with the virtual asset selected by the user (step 314). The session manager 74 then analyzes the asset structure in conjunction with the device information associated with the user device 70 and, based on this information, selects the real asset that has an associated content item in an optimal digital format for the user device 70 (step 316). The criteria for determining the optimal digital format may differ by content type. For video content, the determination may involve one or more of the encoder type, profile, level, resolution, and frame-rate. For example, if the device information indicates that the user device 70 is a HD device, the session manager 74 may select a real asset associated with a content item encoded in a resolution of 1920×1080. As a further example, if a virtual asset is associated with multiple real assets that each have a different resolution, then the session manager 74 may chose the real asset with the resolution that is closest to but not exceeding the maximum resolution indicated in the device information.

The session manager 74 initiates a session create message to the streaming server 76 including a URI to the respective real asset (ASSET_URI) and a media descriptor (step 318). The media descriptor can comprise the parameters required to establish a suitable streaming session with the user device 70, such as the video codec, frame rate, RTSP address and port, and the like. Mechanisms for establishing streaming sessions with user devices are known and will not be described in detail herein. The streaming server 76 creates a session and returns a session identifier (SESSION_ID) to the session manager 74 (step 320). The session manager 74 returns a URI of the respective real asset and the session identifier from the streaming server 76 to the user device 70 (step 322). The user device 70 initiates a media stream request to the streaming server 76 to initiate streaming of the content item associated with the respective real asset (step 324). According to one embodiment of the present invention, the user device 70 uses RTSP to communicate with the streaming server 76; however, any suitable protocol may be utilized. The streaming server 76 then begins streaming the content item to the user device 70 (step 326). While the messaging used to request, initiate, and perform a streaming media session are provided for context for the present invention, it should be appreciated by those skilled in the art that the precise data and sequence of messages communicated between the session manager 74, the streaming server 76, and the user device 70 can differ according to the specific application and implementation.

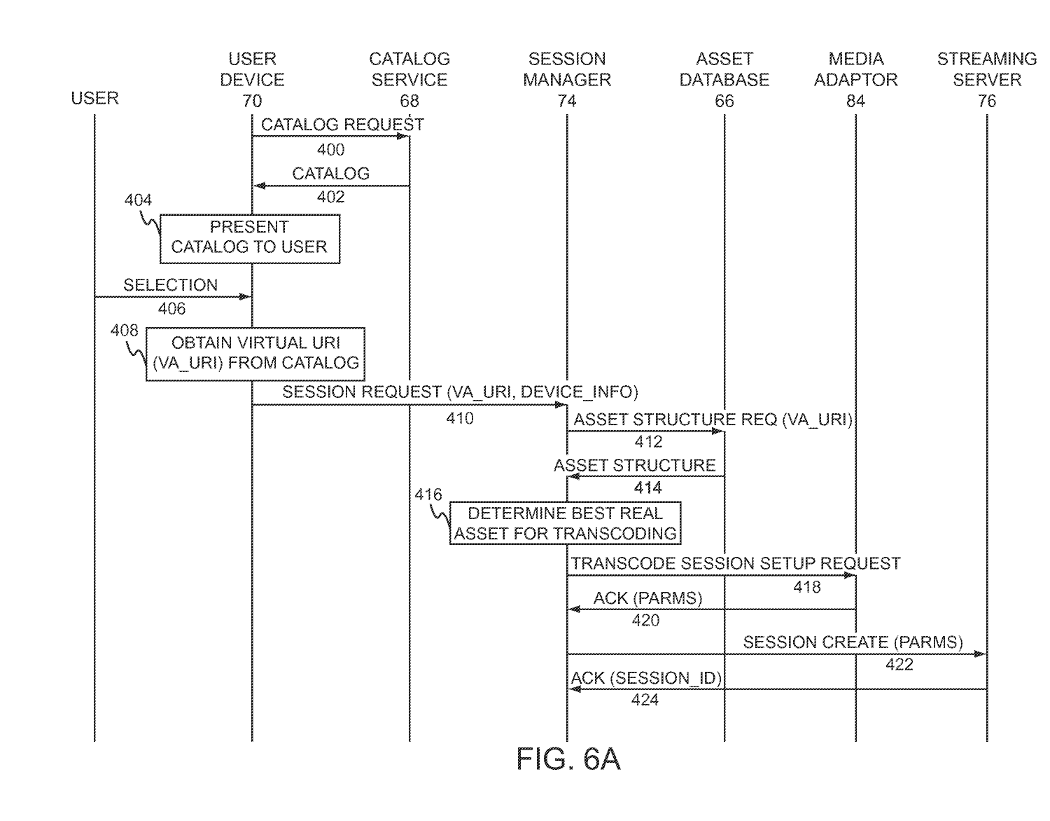

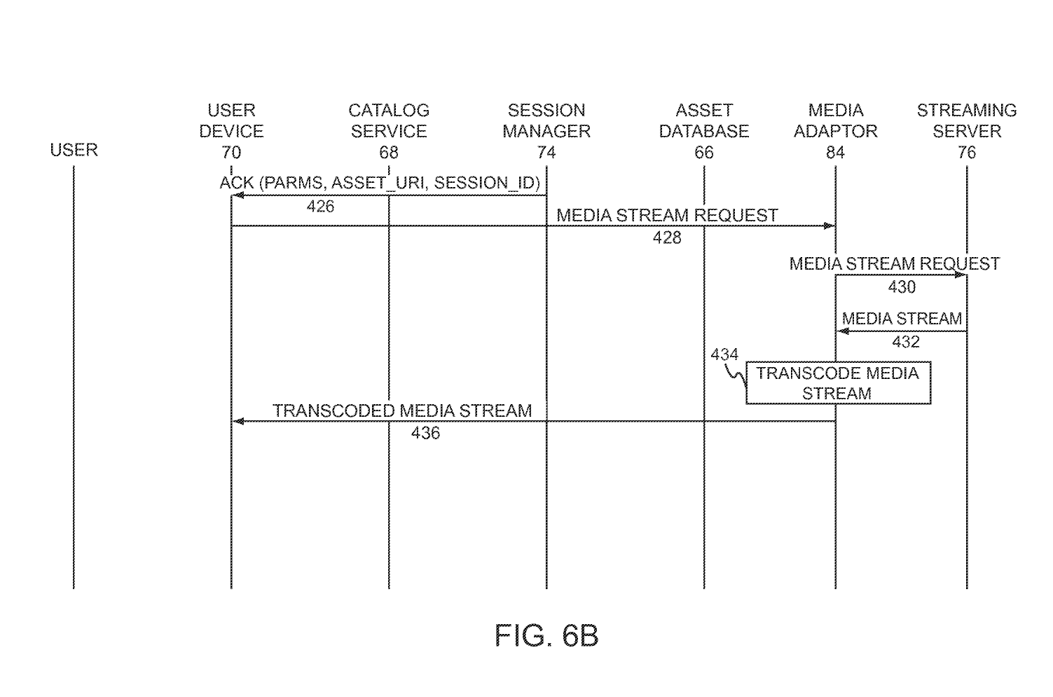

Referring now to FIGS. 6A and 6B, a communication flow is provided to illustrate fulfilling a request for a media presentation wherein an existing content item is transcoded into an optimal digital format for a user device, according to one embodiment of the present invention. The initial steps 400 through 414 relating to requesting a catalog, presenting it to a user, initiating a session, and obtaining a virtual asset associated with the selected presentation are identical to steps 300 through 314 as described with respect to FIG. 5, and will not be repeated herein. The session manager 74 analyzes the real assets in the asset structure associated with the selected virtual asset and determines that no real asset has an associated content item that is in an optimal digital format for the user device 70. However, the session manager 74 determines that a real asset exists in a format suitable for transcoding into an optimal digital format for the user device 70 (step 416). The real asset associated with the respective content item can include metadata identifying whether the content item has been licensed for such transcoding, in accordance with licensing rights obtained from the content provider 60. For example, a manufacturer of high-resolution nature-oriented content may choose to prohibit the transcoding of a real asset from a high definition format to a lower definition format that might be required by a small mobile device. Such metadata may be represented using a policy 20 as illustrated in FIG. 1.

Assuming licensing rights permit such transcoding, the session manager 74 initiates a transcode session setup request to the media adaptor 84 (step 418). The media adaptor 84 returns an acknowledgment (ACK) and certain parameters to the session manager 74 (step 420), such as the streaming IP address and port. The session manager 74 then initiates a session create request with the streaming server 76 (step 422). The streaming server 76 returns an ACK accompanied with a session identifier identifying the new media streaming session to the session manager 74 (step 424). The session manager 74 then returns an ACK, the URI associated with the real asset associated with the content item best suited for generating a transcoded digital media stream, and the session identifier generated by the streaming server 76 to the user device 70 (step 426). The user device 70 initiates a media stream request with the media adaptor 84 (step 428). The media adaptor 84 initiates a media stream request to the streaming server 76 (step 430), which returns a media stream of the content item to the media adaptor 84 (step 432). The media adaptor 84 receives and transcodes the media stream into an optimal digital format for the user device 70 (step 434), and streams the transcoded content item to the user device 70 (step 436).

According to one embodiment of the present invention, as an alternative to the user device 70 requesting a catalog from the catalog service 68 and receiving a catalog of all virtual assets available in the multimedia system, the catalog service 68 may provide a customized catalog identifying only those virtual assets associated with real assets suitable for playing on the user device 70. Alternately, the catalog service 68 can provide the user device 70 a catalog of all the virtual assets, and the user device 70 can select which virtual assets to provide to a user based on the capabilities of the user device 70. Such a customized catalog can prevent an unsatisfactory experience where the user selects a media presentation only to discover there is no associated real asset suitable for playing on the user device 70.

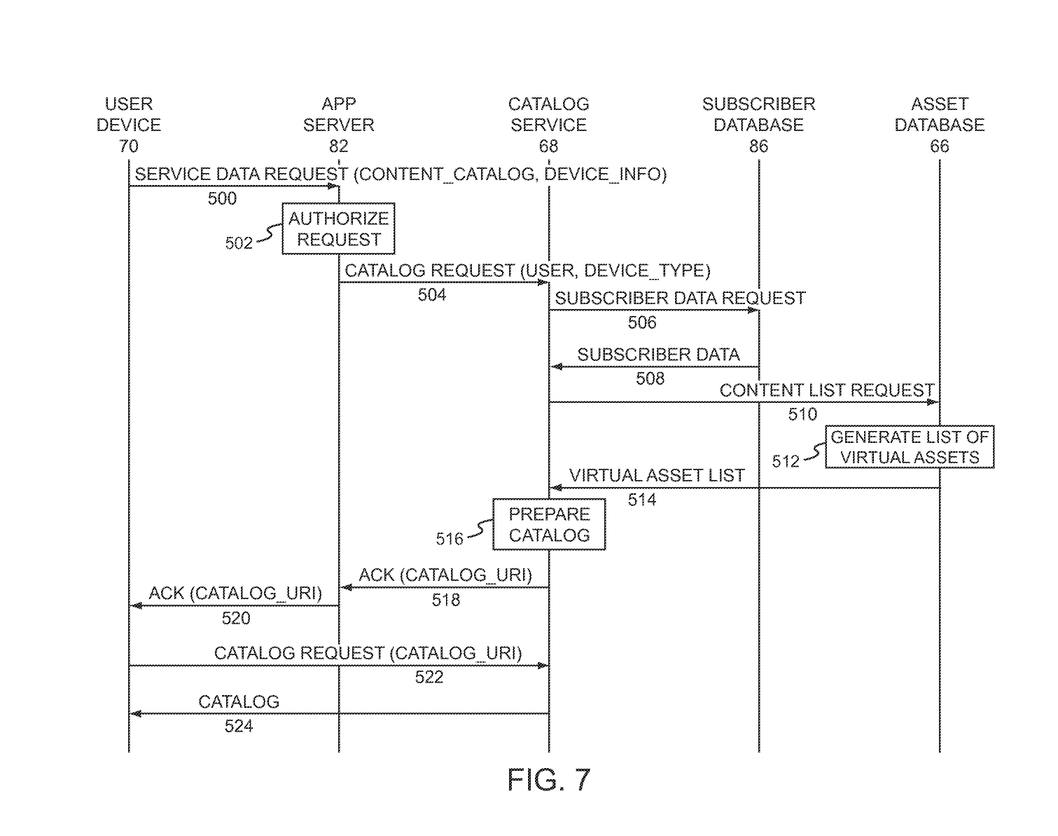

Referring now to FIG. 7, a communication flow is provided to illustrate a process for providing a customized catalog to a user according to one embodiment of the present invention. The embodiment assumes use of a SIP application server 82 which is the recipient of SIP requests. If such a SIP application server 82 is not used, the request may be sent directly to the catalog service 68. The user device 70 initiates a service data request to the application server 82 indicating a desire to obtain a customized catalog (CONTENT_CATALOG) and including device information (DEVICE_INFO) associated with the user device 70 including, for example, a device type, the digital formats playable by the user device 70, and the network capabilities associated with the user device 70 (step 500). The application server 82 can then determine whether this is an authorized request (step 502), and if so can initiate a catalog request to the catalog service 68 that includes a reference to a profile associated with the user of the user device 70, and a device type (DEVICE_TYPE) of the user device 70 (step 504). The catalog service 68 can initiate a subscriber data request to a subscriber database 86, which contains information relating to subscribers, or users, of the multimedia system, including subscription information and program access rights (step 506). The subscriber database 70 returns information relating to the subscriber to the catalog service 68 (step 508).

The catalog service 68 can initiate a content list request to the asset database 66 seeking a list of all the virtual assets in the asset database 66 (step 510), and the asset database 66 can generate a list of such virtual assets and send it to the catalog service 68 (steps 512 and 514). The catalog service 68 can then filter the list of virtual assets by device type to eliminate virtual assets for which there is no associated real asset suitable for the user device 70. The catalog service 68 then prepares a customized catalog based on the filtered list and the subscription information (step 516), and returns a URI (CATALOG_URI) to the customized catalog to the application server 82 (step 518). The application server 82 then returns the URI of the customized catalog to the user device 70 (step 520). The user device 70 can then initiate a catalog request including the URI to the catalog service 68 (step 522) and the catalog service 68 can return the customized catalog to the user device 70 (step 524).

According to another embodiment of the present invention, a user can initiate a request to transfer a media presentation currently playing on a first user device to a second user device. The multimedia system can halt streaming of the media presentation to the first user device, automatically select a real asset in an optimal digital format for the second user device, and initiate streaming of the content item associated with the real asset to the second user device at the same location in the media presentation where streaming was halted on the first user device. For example, a user may be enjoying a video on a mobile device such as a cellular phone. As the user enters their home, the user may desire to watch the remainder of the presentation on a large screen plasma television. The user can initiate a request to the cellular phone to halt streaming of the presentation to the cellular phone and begin streaming the presentation to the plasma television at the same location it was halted on the cellular phone.

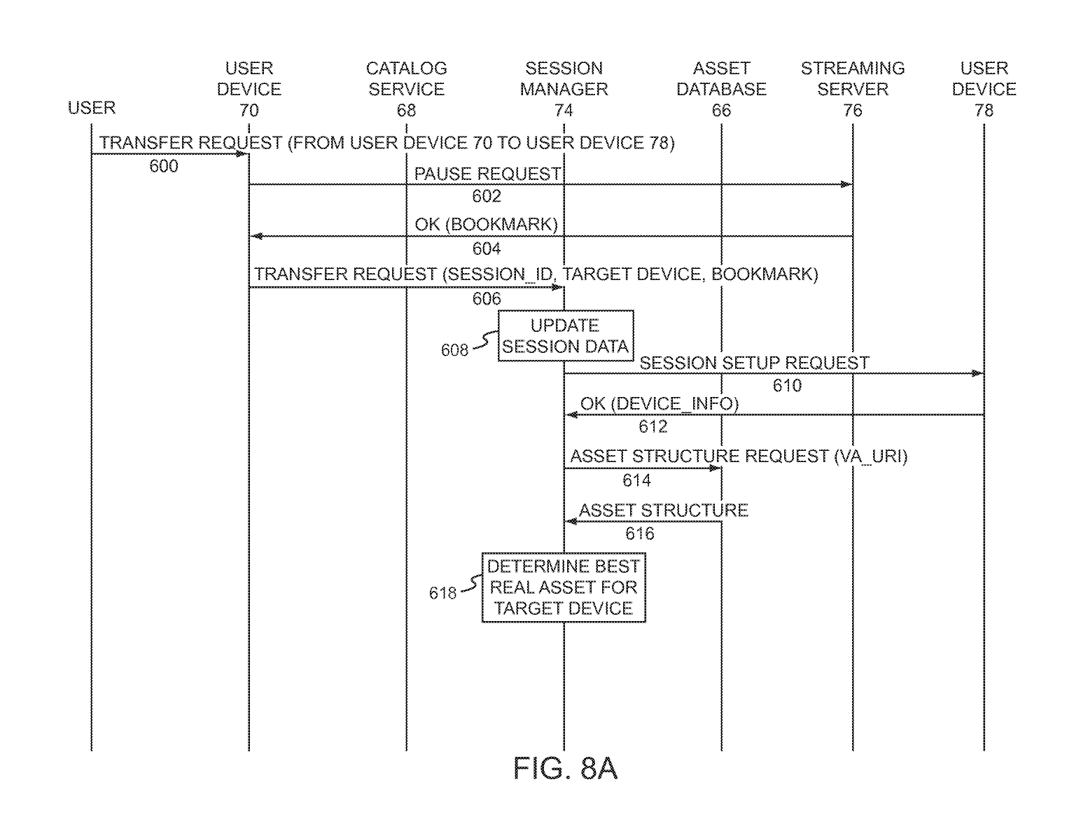

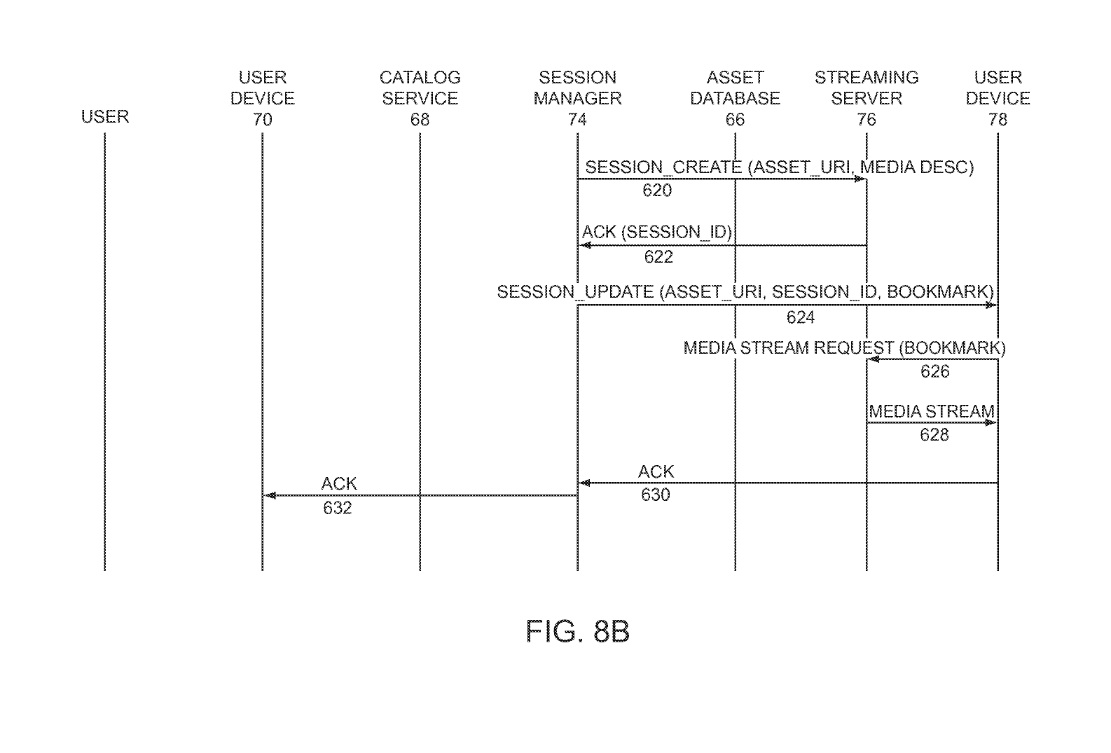

Referring now to FIGS. 8A and 8B, a communication flow is provided to illustrate a transfer of a media presentation streaming from a first device to a second device. The user can indicate to the user device 70 that they desire to transfer the media presentation from the user device 70 to a user device 78 (step 600). The user device 70 can issue a pause request to the streaming server 76 (step 602). The streaming server 76 can return a message to the user device 70 indicating that the media streaming has been paused and can include a bookmark (BOOKMARK) indicating a location in the media presentation where the streaming was halted (step 604). The user device 70 can then initiate a transfer request including the existing session identifier (SESSION_ID), an identifier to the target device, i.e. the user device 78, and the bookmark to the session manager 74 (step 606).

The session manager 74 updates the session data as appropriate (step 608). The session manager 74 then initiates a session setup request to the user device 78 to prepare the user device 78 for the streaming media (step 610). The user device 78 returns an OK message including device information associated with the user device 78 including, for example, a device type, the digital formats playable on the user device 78, and the network capabilities associated with the user device 78 to the session manager 74 (step 612). The session manager 74 can initiate an asset structure request to the asset database 66 including in the request a URI to the virtual asset (VA_URI) associated with the content item that was halted on the user device 70 (step 614), and the asset database 66 can return the requested asset structure to the session manager 74 (step 616). The session manager 74 can then determine the optimal real asset for the user device 78 (step 618).

The session manager 74 then initiates a session create message to the streaming server 76 (step 620) and the streaming server 76 responds to the session manager 74 with an ACK message including a session identifier (step 622). The session manager 74 initiates a session update message to the user device 78 including the URI of the real asset having a content item in an optimal digital format for the user device 78, the session identifier it received from the streaming server 76, and the bookmark indicating where the media presentation had been halted on the user device 70 (step 624). The user device 78 initiates a media stream request including the bookmark to the streaming server 76 (step 626), and the streaming server 76 initiates a media stream of the content item to the user device 78 at the location indicated by the bookmark (step 628). The user device 78 can then initiate an ACK to the session manager 74 (step 630), which in turn passes an ACK to the user device 70 (step 632) indicating the successful transfer of the media presentation from the user device 70 to the user device 78.

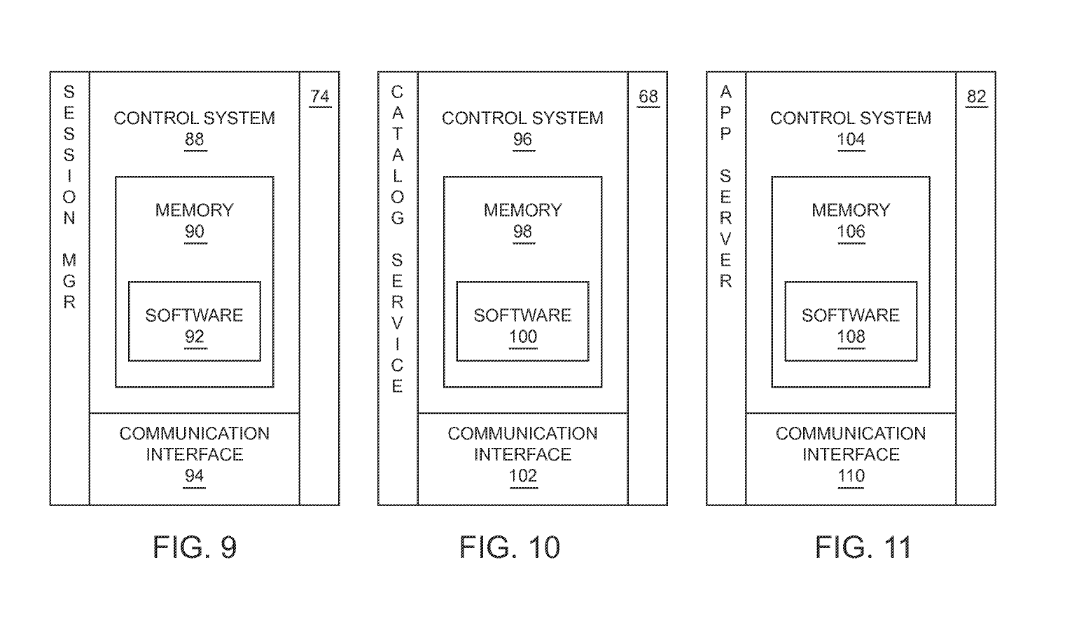

While multiple modules have been described herein for the purpose of illustration, the present invention may be implemented in a single module, or may be divided among a plurality of modules differently than how described herein without departing from the invention. The invention may be implemented in firmware, software executing on a general or special purpose processor, specialized circuitry, or any combination thereof. FIG. 9 illustrates a block representation of the session manager 74 according to one embodiment of the present invention. The session manager 74 may include a control system 88 and associated memory 90. The control system 72 can also include software 92 suitable for carrying out the functionality of the session manager 74 as described herein. The session manager 74 can include a communication interface 94 suitable for communicating with the other modules discussed herein over the network 64.

FIG. 10 illustrates a block representation of the catalog service 68 according to one embodiment of the present invention. The catalog service 68 may include a control system 96 having associated memory 98 and software 100 suitable for carrying out the functionality of the catalog service 68 as described herein. The catalog service 68 can also include a communication interface 102 for communicating over the network 64 with the other modules as described herein.

FIG. 11 illustrates a block representation of the application server 82 according to one embodiment of the present invention. The application server 82 may include a control system 104 having associated memory 106 and software 108 suitable for carrying out the functionality of the application server 82 as described herein. The application server 82 can also include a communication interface 110 for communicating over the network 64 with the other modules as described herein.

Those skilled in the art will recognize improvements and modifications to the preferred embodiments of the present invention. All such improvements and modifications are considered within the scope of the concepts disclosed herein and the claims that follow.

What is claimed is:

1. A method of providing a media presentation to a user device comprising:
receiving device information identifying a device characteristic of the user device;
providing to the user device a virtual asset identifier identifying a virtual asset associated with the media presentation;
receiving a request to play the media presentation associated with the virtual asset;
obtaining a plurality of real assets associated with the virtual asset, each of the plurality of real assets associated with a digital encoding of the media presentation and including format data identifying an encoding characteristic of the respective digital encoding;
selecting as a function of the device information one of the plurality of real assets; and
initiating communication of the digital encoding of the media presentation associated with the one of the plurality of real assets to the user device.

2. The method of claim 1 wherein the virtual asset comprises a data structure including a plurality of real asset identifiers, each real asset identifier identifying one of the plurality of real assets, and wherein each of the plurality of real assets comprises a data structure including an address of the respective digital encoding associated with each of the plurality of real assets.

3. The method of claim 1 wherein the virtual asset has a role of one of a commercial virtual asset and a promotional virtual asset.

4. The method of claim 1 wherein receiving the request to play the media presentation associated with the virtual asset comprises receiving the virtual asset identifier identifying the virtual asset associated with the media presentation.

5. The method of claim 1 wherein selecting as the function of the device information the one of the plurality of real assets and initiating communication of the digital encoding of the media presentation associated with the one of the plurality of real assets to the user device comprises:
determining that none of the plurality of real assets is associated with a digital encoding of the media presentation that is compatible with the user device;
selecting as a function of the device information one of the plurality of real assets;
initiating communication of the digital encoding of the media presentation associated with the one of the plurality of real assets to a transcoder;
transcoding the digital encoding into a second digital encoding that is compatible with the user device; and
initiating communication of the second digital encoding to the user device.

6. The method of claim 5 wherein the one of the plurality of real assets is associated with a policy, and further comprising determining whether the policy indicates a right to transcode the digital encoding associated with the one of the plurality of real assets.

7. The method of claim 6 further comprising determining whether the policy indicates the right to transcode the digital encoding associated with the one of the plurality of real assets into a specific digital format associated with the second digital encoding.

8. The method of claim 1 further comprising:
receiving a request to halt communication of the digital encoding to the user device and to initiate communication of the media presentation on a second user device;
halting communication of the digital encoding to the user device;
receiving second device information identifying a device characteristic associated with the second user device;
selecting as a function of the second device information a second of the plurality of real assets; and
initiating communication of a second digital encoding associated with the second of the plurality of real assets to the second user device.

9. The method of claim 8 wherein the second digital encoding is in a different format than the digital encoding associated with the one of the plurality of real assets.

10. The method of claim 8 further comprising:
determining a stopping position in the digital encoding based on a time of receiving the request to halt communication of the digital encoding; and
initiating communication of the second digital encoding to the second user device at a playing position in the second digital encoding that substantially corresponds to the stopping position.

11. The method of claim 1 wherein selecting as the function of the device information the one of the plurality of real assets comprises:
determining an optimal format as a function of the device information; and
selecting the one of the plurality of real assets that is associated with a digital encoding that is encoded in the optimal format.

12. The method of claim 1 wherein the virtual asset identifier comprises a uniform resource identifier, and wherein the virtual asset includes a plurality of real asset identifiers, each of the plurality of real asset identifiers identifying one of the plurality of real assets associated with the virtual asset.

13. The method of claim 12 wherein the uniform resource identifier comprises a Session Initiation Protocol uniform resource identifier, and wherein each of the plurality of real asset identifiers comprises a Hypertext Transfer Protocol uniform resource identifier.

14. The method of claim 1 wherein the media presentation comprises one of a song and a movie.

15. The method of claim 1 wherein providing to the user device the virtual asset identifier identifying the virtual asset associated with the media presentation comprises providing to the user device a plurality of virtual asset identifiers, each virtual asset identifier identifying a virtual asset associated with a respective media presentation.

16. The method of claim 1 wherein providing to the user device the virtual asset identifier identifying the virtual asset associated with the media presentation comprises selecting a plurality of virtual asset identifiers as a function of the device information, wherein each of the plurality of virtual asset identifiers identifies a virtual asset that is associated with a real asset that is associated with a digital encoding that is formatted in a format compatible with the user device, and providing the plurality of virtual asset identifiers to the user device.

17. A method of providing a media presentation to a user device comprising:
receiving device information identifying a device characteristic of the user device;
providing to the user device a virtual asset identifier identifying a virtual asset associated with the media presentation;
receiving a request to play the media presentation associated with the virtual asset;
obtaining a plurality of real assets associated with the virtual asset, each of the plurality of real assets associated with a digital encoding of the media presentation and including format data identifying an encoding characteristic of the respective digital encoding;
determining that none of the plurality of real assets is associated with a digital encoding of the media presentation that is optimal for the user device;
selecting as a function of the device information one of the plurality of real assets;
initiating communication of the digital encoding of the media presentation associated with the one of the plurality of real assets to a transcoder;
transcoding the digital encoding into a second digital encoding that is optimal for the user device; and
initiating communication of the second digital encoding to the user device.

18. The method of claim 17 wherein the one of the plurality of real assets is associated with a policy, and further comprising determining whether the policy indicates a right to transcode the digital encoding associated with the one of the plurality of real assets.

19. The method of claim 18, further comprising determining whether the policy indicates the right to transcode the digital encoding associated with the one of the plurality of real assets into a specific digital format associated with the second digital encoding.

20. A session manager comprising:
a communication interface adapted to communicate with a network; and
a control system adapted to:
receive device information identifying a device characteristic of a user device;
provide to the user device a virtual asset identifier identifying a virtual asset associated with a media presentation;
receive a request to play the media presentation associated with the virtual asset;
obtain a plurality of real assets associated with the virtual asset, each of the plurality of real assets associated with a digital encoding of the media presentation and including format data identifying an encoding characteristic of the respective digital encoding;
select as a function of the device information one of the plurality of real assets; and
initiate communication of the digital encoding of the media presentation associated with the one of the plurality of real assets to the user device.

21. The session manager of claim 20 wherein the control system is further adapted to:
determine an optimal format as a function of the device information; and
select the one of the plurality of real assets that is associated with a digital encoding that is encoded in the optimal format.

22. The session manager of claim 20 wherein the control system is further adapted to provide a plurality of virtual asset identifiers that are selected as a function of the device information, and wherein each of the plurality of virtual asset identifiers identifies a virtual asset that is associated with a real asset that is associated with a digital encoding that is formatted in a format compatible with the user device, and wherein the control system is adapted to provide the plurality of virtual asset identifiers to the user device.

23. The session manager of claim 20 wherein the virtual asset comprises a data structure including a plurality of real asset identifiers, each of the plurality of real asset identifiers identifying one of the plurality of real assets, and wherein each of the plurality of real assets comprises a data structure including an address of the respective digital encoding associated with the real asset.

24. The session manager of claim 20 wherein the virtual asset has a role of one of a commercial virtual asset and a promotional virtual asset.
